(19) United States
(12) Patent Application Publication
(10) Pub. No.: US 2003/0081565 A1
(43) Pub. Date: May 1, 2003

(54) Method and apparatus for providing communication between a PBX terminal and a public wireless network via a private wireless network

(76) Inventors: Chris P. McIntosh, San Francisco, CA (US); Ian V. Sugarbroad, Menlo Park, CA (US)

Correspondence Address: FLEHR HOHBACH TEST ALBRITTON & HERBERT LLP, Suite 3400, Four Embarcadero Center, San Francisco, CA, 94111-4187, US

(21) Appl. No.: 10/002,551

(22) Filed: Nov. 1, 2001

(51) Int. Cl. H04Q 7/00

(52) U.S. Cl. 370/328; 370/338; 713/150; 713/182

(57) ABSTRACT

A private wireless network (104) and method are provided for facilitating communication between a private branch exchange (PBX) terminal (106) coupled thereto and a public wireless network (102) via an A-link (142). Generally, the private network (104) includes an A-interface (140) through which the PBX terminal (106) is coupled to the public network (102), and a virtual identity module that can be associated with the PBX terminal. Preferably, the module includes subscriber and security information for the PBX terminal (106). In one embodiment, the module comprises information stored in a memory system (100) coupled to the private network (104). Alternatively, the module comprises a card (150) held in a card holder/reader (152) in the private network (104). The public network (102) can be either a Global System for Mobile Communications (GSM) or a third-generation(3G) network. For a GSM network, the module is a virtual subscriber identity module (SIM). For a 3G network, the module is a virtual universal subscriber identity module (USIM).

### FIELD

The present invention relates generally to wireless communication networks, and more particularly to a method and apparatus for providing communication between a public wireless network coupled to a private wireless network via an A-link and a PBX terminal coupled thereto.

### BACKGROUND

The use of mobile communication devices including cellular telephones, pagers, wireless internet access appliances and facsimile machines has increased exponentially in recent years. This increased demand for mobile communication devices has led to rapid growth in the public and private infrastructure required to support these services.

A block diagram of a prior art communication system 10 including both a private wireless network 12 and a public wireless network 14, is shown in FIG. 1. Referring to FIG. 1, a conventional public wireless network 14 typically includes a mobile switching center (MSC 16) that is coupled to and communicates with the public switched telephone network (PSTN 18) via a land line 20. The MSC 16 is further coupled via an A-link 22 to a number of base station controllers (BSC 24), only one of which is shown. Each BSC 24 in turn communicates via an Abis link 25 with one or more base transceiver station (BTS 26), only one of which is shown, that in turn communicates with a public wireless mobile station 28 via an antenna 29.

Private wireless networks 12 are often coupled to and maintained in conjunction with a private branch exchange (PBX 30) by an enterprise to provide increased mobility of communication at a site or between sites at an economical cost. Private wireless networks 12 generally may include an access point or a private BSC/MSC 31 having a rate-protocol adapter 32 through which the private wireless network is coupled to the PBX 30. The BSC/MSC 31 further includes one or more processors 34 shared between the private BSC/MSC and one or more private BTSs 35 for decoding the inbound signals and encoding the outbound signals. Each BTS 35, only one of which is shown in detail, includes one or more receivers 36 for receiving inbound signals, one or more transmitters 38 for transmitting outbound signals, a diplexor 40 and a common antenna 42 for each receiver and transmitter pairs.

In addition, in the communication system 10 shown the private wireless network 12 further includes an A-interface 44 in the private BSC/MSC 31 for coupling the private wireless network directly to the public wireless network 14 via an A-link 46. This arrangement, allows both private wireless mobile stations 48 and public wireless mobile stations 28-1 to communicate with mobile communication devices through the public wireless network 14 without being routed over the PSTN 18.

While a vast improvement over conventional communication systems encompassing public and private wireless networks 14, 12, this approach is not wholly satisfactory for a number of applications. One problem with the above approach is that PBX telephones 50, coupled to the private wireless network 12 via the PBX 30, lack the subscriber and security information, such as encryption keys found in mobile stations, and therefore cannot access the public wireless network 14 directly over the A-link 46. Thus, a call for a PBX telephone 50 originating in the public wireless network 14 must be completed over the land line 20 and through the PSTN 18. Similarly, an outgoing call from the PBX telephone 50 for a mobile station 28, 48, not found in the service area of the private wireless network 12 must be completed through the PSTN 18 and over the land line 20.

Accordingly, there is a need for an apparatus and method of connecting a call between a telephone, computer or facsimile machine coupled through a PBX terminal to a private wireless network to a public wireless network over an A-link. There is a further need for an apparatus and method of providing supplementary services including forwarding, transferring or conferencing a call between the public and private wireless mobile stations connected over the A-link to a telephone, computer or facsimile machine coupled to the private wireless network through a PBX terminal in a manner that is substantially transparent to all parties to the call. There is a still further need for an apparatus and method of providing supplementary services including forwarding, transferring or conferencing a call between public mobile stations, between a public mobile station and a private mobile station, and between private mobile stations connected over the A-link to a public wireless network.

The system and method of the present invention provides these and other advantages over the prior art.

### SUMMARY

It is an object of the present invention to provide a method and apparatus for communicating between a PBX terminal and a public wireless network via a private wireless network.

It is a further object of the present invention to provide a method and apparatus for generating a call record for billing purposes.

It is a still further object of the present invention to provide a method and apparatus for address translation and call routing based on subscriber and/or endpoint that optimizes call routing.

It is a yet further object of the present invention to provide a method and apparatus for providing authentication an encryption algorithm support for a PBX terminal communicating between a public wireless network via a private wireless network.

In one aspect, the present invention is directed to a private wireless network for communicating with a public wireless network coupled thereto via an A-link. Generally, the private wireless network includes at least one virtual identity module to enable a terminal of a private branch exchange (PBX) coupled to the private wireless network to communicate with the public wireless network via the A-link. The virtual identity modules include algorithms or key to support authentication an encryption calculations by the PBX, PBX terminal or private wireless network. Optionally, the private wireless network further includes a memory system and means for generating and maintaining call records for billing purposes. Preferably, the private wireless network further includes an A-interface, such as a Private A-link Intelligent Multiplexor (PALIM) interface function, through which the PBX terminals and public and private wireless mobile stations are coupled to the public wireless network. More preferably, the virtual identity module includes subscriber identification and security information for the PBX terminal.

The virtual identity modules can be associated with the PBX terminals on a one-to-one basis; on a one-to-many basis; or on a many-to-many basis in which the virtual identity modules can be maintained as a pool of virtual identity modules that are associated temporarily with any PBX terminal on an as needed basis. Additionally, the virtual identity modules can be associated with the PBX terminals on a many-to-one basis to provide a single PBX terminal with several numbers by which it can be accessed. This enables the callers from the public wireless network to reach the same terminal by dialing different numbers, or a user to select different numbers to be used for record and billing purposes. Alternatively, each virtual identity modules can include multiple different user profiles that can be selected by a user and used for record and billing purposes. For example, a user placing a call from a PBX terminal over the public wireless network could enter a first code selecting a first user profile when the call is for business purposes, and a second when the call is private.

In one embodiment, the virtual identity module includes subscriber identification and security information stored in the memory system. Alternatively, the private wireless network further includes a card holder/reader, and the virtual identity module includes one or more cards held in the card holder/reader.

The public wireless network can be either a Global System for Mobile Communications (GSM) network, a third-generation (3G) mobile communications network, a Code Division Multiple Access (CDMA) network, a Personal Communications Services (PCS) network, or a Personal Handiphone System (PHS) network. The private wireless network can be a standard or any other wireless network implementing PCS or PHS, such as a Hiperlan network or an 802.11 network. Where the public wireless network is a GSM network, the virtual identity module is a virtual subscriber identity module (virtual SIM).Where the public wireless network is a 3G network, the virtual identity module is a virtual universal subscriber identity module (virtual USIM).

In another aspect, the present invention is directed to a method of facilitating communication in a communication system having a public wireless network, a PBX with a number of PBX terminals coupled thereto, and a private wireless network coupled to the public wireless network via an A-link and to the PBX. Generally, for a call originating from the PBX terminal the method includes the steps of: (i) registering the virtual identity module associated with each PBX terminal with the public and private MSC; (ii) receiving in the private wireless network call information from one of the PBX terminals; (iii) providing subscriber identification and security information for the PBX terminal to the public wireless network; and (iv) coupling the PBX terminal to the public wireless network over the A-link. For a call to the PBX terminal originating from public wireless network the method includes the steps of: (i) registering the virtual identity module associated with each PBX terminal with the public and private MSC; (ii) receiving in the private wireless network call information from the public wireless network; (iii) providing subscriber identification and security information for the PBX terminal to the public wireless network; and (iv) coupling the public mobile station to the PBX terminal through the private wireless network over the A-link. It will be appreciated that in either instance the registration of the virtual identity module associated with the public and private MSCs can, and generally does, occur only when the PBX terminal is provisioned, or originally provided with access to the public wireless network over the A-link.

Preferably, the private wireless network includes a PALIM interface function as described above, and the step of coupling the PBX terminal to the public wireless network over the A-link includes coupling the PBX terminal to the public wireless network over the A-link via the PALIM interface function. More preferably, the private wireless network includes a number of virtual identity modules each having subscriber identification and security information stored therein, and the step of providing subscriber identification and security information for the PBX terminal to the public wireless network includes the step of providing subscriber identification and security information from a virtual identity module associated with the PBX terminal.

In one embodiment, the private wireless network further includes a memory system, and the step of providing subscriber identification and security information for the PBX terminal to the public wireless network is accomplished by reading subscriber identification and security information from that stored in the memory system. Alternatively, where the private wireless network includes a card holder/reader, and the step of providing subscriber identification and security information for the PBX terminal to the public wireless network includes the step of reading subscriber identification and security information stored in a card held in the card holder/reader.

The apparatus and method of the present invention is particularly useful in or for situations in which it is necessary or desirable to transfer a call to or from the PBX terminal. For example, where the communication system further includes a public switched telephone network (PSTN), the step of receiving in the private wireless network call information from one of the number of PBX terminals can involve receiving in the private wireless network call information for a call originating in the PSTN and forwarded from one of the PBX terminals.

In another example, where the private wireless network is capable of communicating with public and private wireless mobile stations, the step of receiving in the private wireless network call information can involve receiving call information for a call originating from a public or a private wireless mobile station and forwarded from one of the PBX terminals.

In yet another example, the private wireless network is capable of coupling communications between the public wireless network and public or private wireless mobile stations, and the step of receiving call information involves receiving call information for a call originating from a three party call between a first party connected to the public wireless network, a second party connected to the private wireless network over a public wireless mobile station or a private wireless mobile station, and a third party connected to the private wireless network from one of the number of PBX terminals. In one embodiment, call information from the PBX terminal is received when the second party is disconnected from the three party call, thereby enabling uninterrupted communication between the first party connected to the public wireless network and the third party connected to the private wireless network from one of the number of PBX terminals.

Advantages of the apparatus and method of the present invention include any or all of the following:

(i) ability to call to and from a PBX terminal to a public wireless network through a private wireless network over an A-link;

(ii) ability to forward, transfer or conference a call between the public wireless network and a private wireless mobile station to a PBX terminal coupled to private wireless network in a manner that is substantially transparent to all parties to the call;

(iii) ability to forward, transfer or conference a call between public mobile stations, between a public mobile station and a private mobile station, and between private mobile stations connected over the A-link to a public wireless network; and

(iv) ability to utilize local switching to optimize call routing based on subscriber and/or endpoint information.

### BRIEF DESCRIPTION OF THE FIGURES

These and various other features and advantages of the present invention will be apparent upon reading of the following detailed description in conjunction with the accompanying drawings, where:

FIG. 1 (prior art) is an exemplary block diagram of a prior art communication system including a public and private wireless network;

FIG. 2 is an exemplary block diagram of a communication system including a private wireless network incorporating virtual identity modules for enabling a private branch exchange (PBX) terminals to communicate with a public wireless network according to an embodiment of the present invention;

FIG. 3 is a flowchart showing an embodiment of a process for facilitating communication between a private branch exchange (PBX) terminal coupled to a private wireless network and a public wireless network according to an embodiment of the present invention;

FIG. 4 is a schematic diagram showing call routing for a call made between a public switched telephone network (PSTN) terminal and a private branch exchange (PBX) terminal which is forwarded to a public wireless network according to an embodiment of the present invention;

FIG. 5 is a schematic diagram showing call routing for a call made between a public or private wireless mobile station and a private branch exchange (PBX) terminal which is forwarded to a public wireless network according to an embodiment of the present invention; and

FIG. 6 is a schematic diagram showing call routing for a three party call between a first party connected to a public wireless network, a second party connected to the private wireless network over a public or private wireless mobile station, and a third party connected to the private wireless network from a private branch exchange (PBX) terminal according to an embodiment of the present invention.

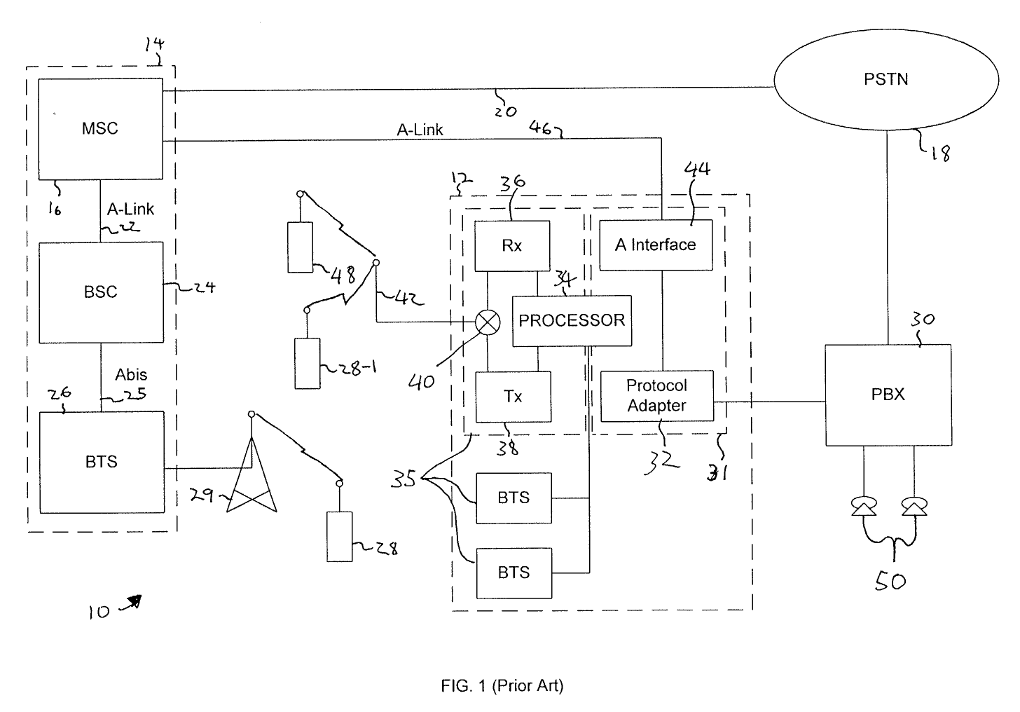

### DETAILED DESCRIPTION

The present invention is directed to a communication system having a public wireless network, a private branch exchange (PBX) with a number of PBX terminals coupled thereto, and a private wireless network coupled to the public wireless network via an A-link and to the PBX, and a method for operating the same to enable the PBX terminals to communicate with the public wireless network via the A-link.

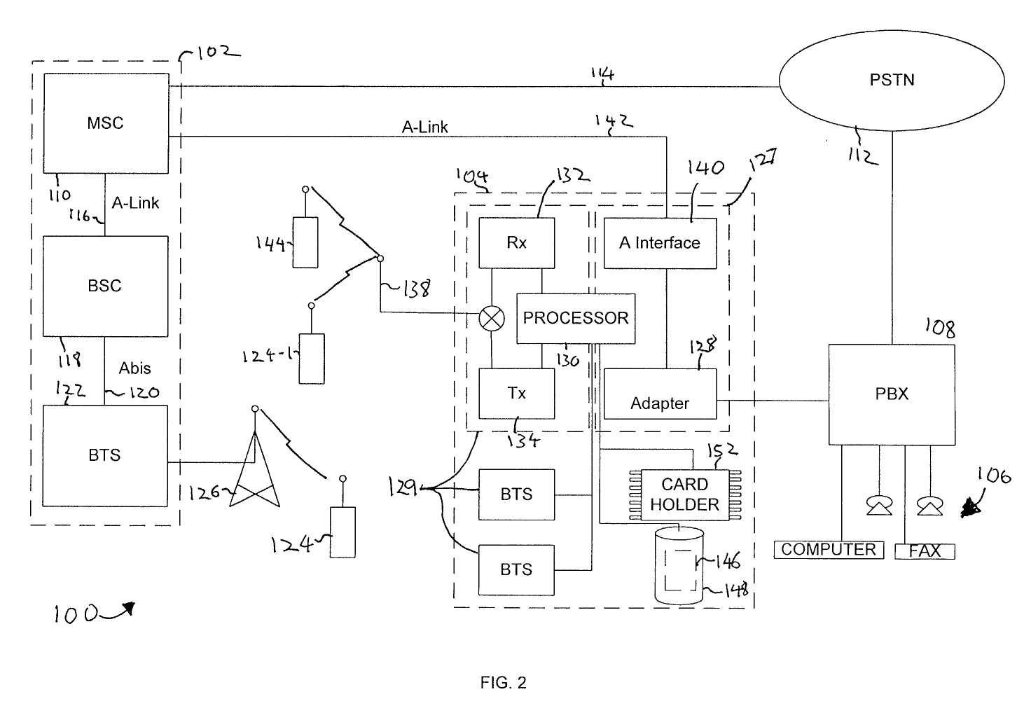

A communication system according to the present invention will now be described with reference to FIG. 2. FIG. 2 is an exemplary block diagram of a communication system 100 including a public wireless network 102 and a private wireless network 104 incorporating virtual identity modules according to an embodiment of the present invention to enable PBX terminals 106 of a PBX 108 to communicate with the public wireless network. For purposes of clarity, many of the details of communication systems 100 and in particular of public and private wireless networks 102, 104, that are widely known and are not relevant to the present invention have been omitted.

Referring to FIG. 2, the public wireless network 102 can be either a Global System for Mobile Communications (GSM) network, a third-generation (3G) mobile communications network, a Code Division Multiple Access (CDMA) network, a Personal Communications Services (PCS) network, or a Personal Handiphone System (PHS) network. The private wireless network can be a standard or any other wireless network implementing PCS or PHS, such as a Hiperlan network or an 802.11 network. Generally, the public wireless network 102 includes a mobile switching center (MSC 110) that is coupled to and communicates with a public switched telephone network (PSTN 112) via a land line 114. The MSC 110 is further coupled via an A-link 116 to a number of base station controllers (BSC 118), only one of which is shown. Each BSC 118 in turn communicates via an Abis link 120 with one or more base transceiver station (BTS 122), only one of which is shown, that in turn communicates with a public wireless mobile station 124 via an antenna 126.

The private wireless network 104 can include a private BSC/MSC 127 and one or more private BTSs 129, only one of which is shown in detail. Alternatively, the private wireless network 104 can include similar access point for radio resource management and routing switching mechanisms related to MSC functions performed by an or a private BSC/MSC 127. The private BSC/MSC 127 includes an adapter 128, such as a transmission rate adapter unit (TRAU), for transcoding or adapting data transmission protocols and rates between the private wireless network and the PBX 108. More particularly, the adapter 128 converts information from the PBX 108 to a mobile system format, such as a GSM or 3G format, and information from the private wireless network 104 to a format, such as an Integrated Standard Digital Network (ISDN) format, used by the PBX. It will be appreciated however that transcoding is not necessary in every instance. For example, transcoding is generally not necessary for IP enabled telephones or computers connected through the PBX 108.

The private BSC/MSC 127 further includes one or more processors 130 shared with BTSs 129 decode the inbound signals and encode the outbound signals decodes the inbound signals and encodes the outbound signals. Each BTS 129 includes a receiver 132 for receiving the inbound signals, and a transmitter 134 for transmitting the outbound signals. A diplexor 136 enables a common antenna 138 to receive and transmit both the inbound and the outbound signals. It should be noted that the antenna 138 can be separate from the other components or elements of the private wireless network 104, as shown, or all elements of the private wireless network including the antenna can be enclosed in a common enclosure (not shown).

In addition, in the private wireless network 104 shown the private BSC/MSC 127 further includes an A-interface 140 for coupling the private wireless network directly to the public wireless network 102 via an A-link 142. This arrangement, described in detail in commonly assigned U.S. Pat. Nos. 5,818,824, and 5,999,813, which are incorporated herein by reference, allows both private wireless mobile stations 144 and public wireless mobile stations 124-1 to communicate with mobile communication devices through the public wireless network 102 without being routed over the PSTN 112. Preferably, the A-interface 140 is a Private A-Link Intelligent Multiplexor (PALIM) interface function as described in commonly assigned U.S. Pat. No. 5,818,824, and commercially available from interWAVE Communications International Inc., of Menlo Park, Calif. A PALIM interface function, enables the private wireless network 104 to act as a wireless extension to a private communications network (not shown) encompassing one or more PBXs 108 and to act as an extension to the public wireless network 102 on a call-by-call basis.

Generally, the private wireless network 104 can include any commercially available wireless network having an integrated A-interface 140 and capable of being coupled to a PBX 108 and via an A-link 142 to a public wireless network 102. One suitable example is a Network In a Box (NIB) from interWAVE Communications International Ltd., of Menlo Park, Calif., which can integrate with most PBXs to provide wireless interoperability with a private communications network, and includes a PALIM interface function as described above.

In accordance with the present invention, the private wireless network 104 further includes a number of identity modules or virtual identity modules that enable the PBX terminals 106 to couple to and communicate with the public wireless network 102 through the A-interface 140 and over the A-link 142. Generally, the virtual identity modules provide subscriber identification or information and security information, such as authentication or encryption keys, to the public wireless network 102 and/or private wireless network 104 when a call is made or forwarded from a PBX terminal 106, or transferred thereto. For example, where the private wireless network 104 further includes a processor 130 to execute algorithms to authenticate, encrypt outbound signals and decrypt inbound signals, the virtual identity module includes authentication and encryption keys for the associated PBX terminal 106. Additionally or similarly, where the processor 130 is adapted or configured to provide supplementary services, such as forwarding, transferring or conferencing a call between public mobile stations, between a public mobile station and a private mobile station, and between private mobile stations connected over the A-link to a public wireless network, the virtual identity module includes supplementary service keys to support supplementary services for the associated PBX terminal 106.

More particularly, where the public wireless network 102 is a GSM network, the virtual identity modules provide information similar to or substantially the same as that provided by Subscriber Identity Module (SIM) cards commonly found in GSM mobile telephones. Where the public wireless network 102 is a 3G network, the virtual identity modules provide information similar to or substantially the same as that provided by Universal Subscriber Identity Module (USIM) cards commonly found in the latest generation of 3G mobile telephones.

The number of virtual identity modules can be equal to the number of PBX terminals 106 and each virtual identity module can be permanently associated on a one-to-one basis with one of the PBX terminals. Alternatively, the virtual identity modules can be associated with the PBX terminals 106 on a one-to-many basis in which a single virtual identity module is associated with a subset of the PBX terminals, or on a many-to-many basis in which the virtual identity modules can be maintained as a pool of virtual identity modules any one of which can be associated temporarily with any PBX terminal on an as needed basis.

Generally, if the virtual identity modules are associated on a one-to-one basis with a PBX terminal 106, whenever a new PBX terminal is provisioned or added a virtual identity module is associated with it and registration for the PBX terminal passed to the private BSC/MSC 127 and through the A-link 142 to the MSC 110 in the public wireless network 102. If the virtual identity modules are associated with the PBX terminals 106 on a one-to-many basis or on a many-to-many basis registration with the private BSC/MSC 127 and the MSC 110 in the public wireless network 102 may not be necessary. Rather, the added PBX terminal 106 and the associated virtual identity modules are locally registered within the private communication system or PBX 108.

In one embodiment, each virtual identity modules can include multiple different user profiles that can be selected by a user and used for record and billing purposes. For example, a user placing a call from a PBX terminal over the public wireless network could enter a first code selecting a first user profile when the call is for business purposes, and a second when the call is private. In this embodiment, whenever a new PBX terminal 106 is provisioned or added the virtual identity module and the user profile or profiles associated with it are passed to the private BSC/MSC 127 and through the A-link 142 to the MSC 110 in the public wireless network 102 to register the PBX terminal and users.

When the virtual identity module is associated with a number of PBX terminals or with multiple different user profiles, a call into the private communication system from the public wireless network 102 can be connected to the proper PBX terminal through the use of a directory such as found in many PBXs 108 and private communication systems. Thus, a particular virtual identity module can be associated with all telephones of a group within an enterprise, such as a technical support group, or based on the type of or location of the PBX terminal 106. For example, a caller into the private communication system from the public wireless network 102 would be connected to the PBX 108 through the private wireless network 104 over the A-Link 142 using the virtual identity module. The caller would then be directed by a directory to select a particular individual within the technical support group and switched locally within the private communication system, i.e., the PBX 108.

The invention can also enable a caller calling into the private communication system from the public wireless network 102 to automatically select from among several different user profiles associated with a single virtual identity module by calling a particular number. For example, calls to two different phone numbers placed in the public wireless network may be connected to a single PBX terminal 106 by means of the associated virtual identity module. One number could indicate to a record keeping and billing subsystem that the call is for business purposes, while the other could indicate that the call was personal. Alternatively, the virtual identity module can allow the caller to automatically select between multiple users sharing a single PBX terminal 106. Optionally, the PBX 108 or the private communication system can provide a distinctive audio or visual signal to alert all users as to who is being called.

In another embodiment, the virtual identity modules encompass subscriber identification and security information stored in data files or records in a database 146 of a memory system 148 coupled to the private wireless network 104. The memory system 148 can include one or more fixed or removable magnetic, optical, or magnetic-optical disk drives (not shown). Alternatively, the memory system 148 can include one or more Random Access Memory (RAM) devices, including dynamic RAM (DRAM), static RAM (SRAM), and future RAM technologies as they become commercially available. Preferably, the memory system 148 includes one or more read only memory (ROM) devices (not shown), such as an electronically erasable or flash programmable ROM (EEPROM) that can be programmed to enable the memory system to store subscriber identification and security information according to the present invention. As noted above, the data files or records stored in the memory system 148 can be associated on a one-to-one basis with the PBX terminals 106, or maintained simply as a pool of virtual identity modules that are associated temporarily with a PBX terminal on an as needed basis. It should be noted that although the memory system 148 is shown as separate from the other components or elements of the private wireless network 104, it can be enclosed within a common enclosure (not shown).

Storing virtual identity modules in the memory system 148 has the advantage of enabling the pool of virtual identity modules available to be readily scaled to meet changes in the number or type of PBX terminals 106 coupled to the private wireless network 104. Furthermore, the information stored in the memory system 148 can be readily changed to accommodate changes to the public wireless network 102 or in the link 142 coupling the private wireless network 104 thereto. For example, when a GSM public wireless network is upgraded or replaced with a 3G network, the information stored in the memory system 148 can be quickly and easily changed to provide virtual USIMs rather than virtual SIMs without the need to purchase or install additional components. Moreover, during a changeover or transition period from GSM to 3G or to a subsequent standard or protocol, the information stored in the memory system 148 can include virtual identity modules for both protocols, thereby enabling the private wireless network 104 to facilitate communication between the PBX terminals 106 and multiple different public wireless network 102 over one or more different links.

Alternatively, the virtual identity modules can encompass a number of cards 150 held in a card holder/reader 152 in or coupled to the private wireless network 104. The cards 150 can include SIM cards, such as commonly found in GSM mobile telephones, or USIM cards, such as used in the latest generation of 3G mobile telephones. Although, the number of cards 150 held in the card holder/reader 152, and hence the number of virtual identity modules available, is limited by the size of the card holder/reader, both card holder/readers and cards are readily available. Therefore, the card holder/readers 152 and/or cards 150 can be relatively inexpensively and quickly replaced to increase the number of virtual identity modules available. Furthermore, as in the previous embodiment the cards 150 can be quickly replaced to accommodate changes in the public wireless network 102 or in the link 142 thereto. Finally, as in the above embodiment the cards 150 held in the card holder/reader 152 can include a number of both SIM cards and USIM cards to facilitate communication with multiple different public wireless networks.

Optionally, the private wireless network 104 can be adapted to register a public or private wireless mobile station 124, 144, presence and to automatically forward all calls directed to the mobile station first to a PBX terminal 106 for the mobile station subscriber. Thus, local switching of the call allows more efficient utilization of the private wireless network 104 resources.

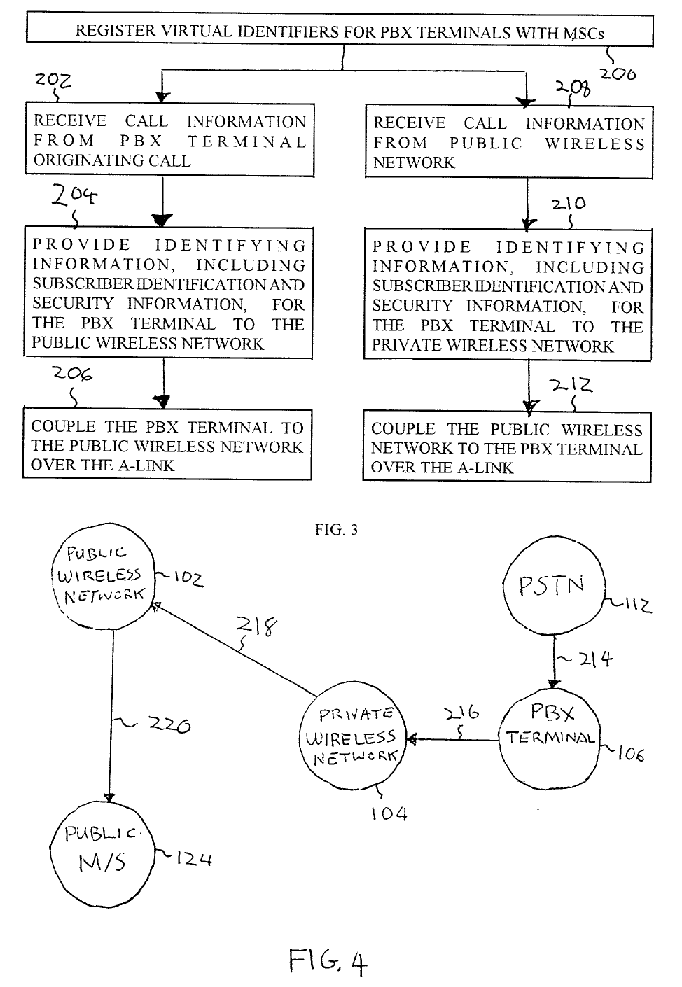

A method or process for operating communication system 100 according to an embodiment of the present invention will now be described with reference to FIG. 3. FIG. 3 is a flowchart showing steps of a method for facilitating communication between a PBX terminal 106 coupled to a private wireless network 104 and a public wireless network 102 using virtual identification modules and an A-interface. In the method, virtual identification modules associated with a PBX terminal 106 or terminals are registered with the private BSC/MSC 127 and, through the A-link 142, with the MSC 110 in the public wireless network 102 the when they are added to the system or otherwise become available for service (step 200). When a call originates from one of the PBX terminals 106, call information is received in the private wireless network 104 from the PBX terminal (step 202). Identifying information for the PBX terminal 106, including subscriber identification and security information, is provided to the public wireless network 102 (step 204), and the PBX terminal coupled to the public wireless network over the A-link 142 (step 206). Preferably, the private wireless network 104 includes a PALIM interface function, and the step of coupling the PBX terminal 106 to the public wireless network 102 over the A-link 142, step 206, includes coupling the PBX terminal to the public wireless network over the A-link via the PALIM interface function. More preferably, the private wireless network 104 includes a number of virtual identity modules each having subscriber identification and security information stored therein, and the step of providing subscriber identification and security information for the PBX terminal 106 to the public wireless network 102, step 204, includes the step of providing subscriber identification and security information from a virtual identity module associated with the PBX terminal.

In one embodiment, the private wireless network 104 includes a memory system 148, and the step of providing subscriber identification and security information for the PBX terminal to the public wireless network, step 204, is accomplished by reading subscriber identification and security information from that stored in the memory system. Alternatively, the private wireless network 104 includes a card holder/reader 152, and the step of providing subscriber identification and security information for the PBX terminal 106 to the public wireless network 102, step 204, includes the step of reading subscriber identification and security information stored in a card 150 held in the card holder/reader.

When a call originates in a public wireless mobile station 124, call information is passed from the public wireless network 102 to the private wireless network 104 from the PBX terminal (step 208). Identifying information, including subscriber identification and security information, is provided to the private wireless network 104 (step 210), and the PBX terminal 106 coupled to the public wireless network over the A-link 142 (step 212).

The apparatus and method of the present invention are particularly useful for situations in which it is necessary or desirable to transfer, forward or conference a call to or from a PBX terminal 106. For example, where the communication system 100 includes a PSTN 112, the step of receiving call information from a PBX terminal 106, step 204, can involve receiving call information for a call originating in the PSTN and forwarded from the PBX terminal to a public or private wireless mobile station 124, 144, over the public wireless network 102.

A schematic diagram showing call routing for a call made from the PSTN 110 to a PBX terminal 106 and forwarded to the public wireless network 102 according to an embodiment of the present invention is illustrated in FIG. 4. As represented by arrow 214 a call originating from the PSTN 112 is connected to the PBX terminal 106. From the PBX terminal 106 the call, along with subscriber and security information, such as authentication, provided by the virtual identity module, is forwarded to the private wireless network 104, arrow 216. The call is then connected over the A-link 142 to the public wireless network 102, arrow 218, and from there transmitted to a public wireless mobile station 124, arrow 220.

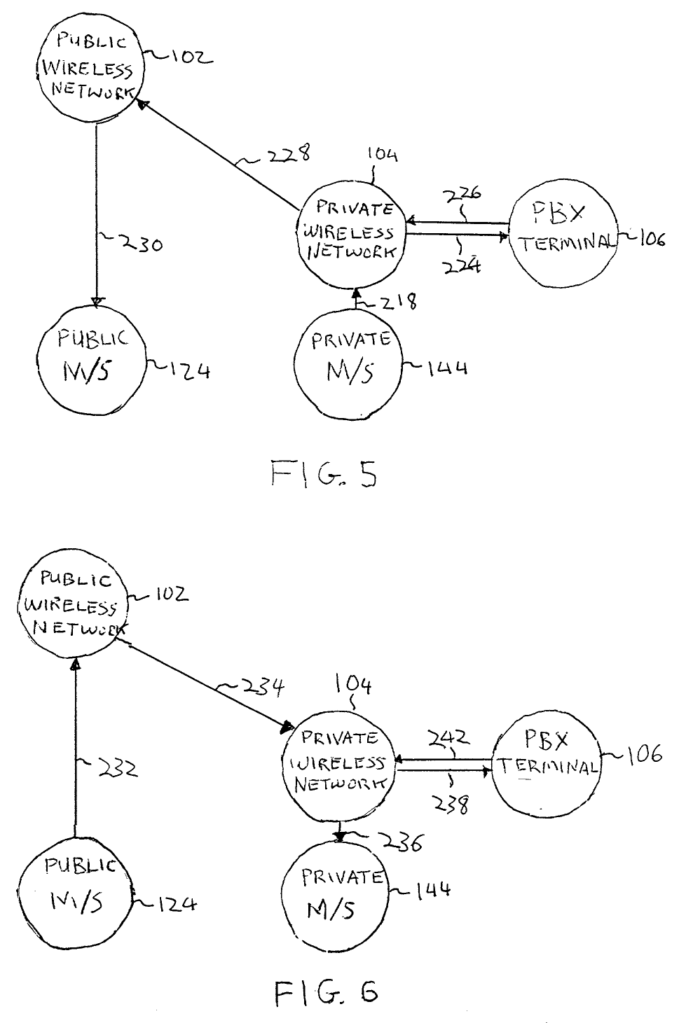

In another example, illustrated in FIG. 5, where the private wireless network 104 can communicate with public and private wireless mobile stations 124, 144, the step of receiving in the private wireless network call information, step 202, can involve receiving call information for a call originating from a public or a private wireless mobile station and forwarded from the PBX terminal 106. Referring to FIG. 5, a call originating from a private (or public) wireless mobile station 144 is connected to the private wireless network 104, arrow 222. From the private wireless network 104 the call is transferred to the PBX terminal 106, arrow 224, which then forwards the call, along with subscriber and security information provided by the virtual identity module, back to the private wireless network, arrow 226. The call is then connected over the A-link 142 to the public wireless network 102, arrow 228, and from there transmitted to a public wireless mobile station 124, arrow 230.

In yet another example, illustrated in FIG. 6, the private wireless network 104 can couple communications between the public wireless network 102 and public or private wireless mobile stations 124, 144, and the step of receiving call information, step 202, is accomplished by receiving call information for a call originating from a three party call between a first party connected to the public wireless network, a second party connected to the private wireless network over a public wireless mobile station or a private wireless mobile station, and a third party connected to the private wireless network from a PBX terminal 106. In one version of this embodiment, call information is received from the PBX terminal 106 only when the second party is disconnected from the three party call, thereby providing uninterrupted communication between the first party connected to the public wireless network 102 and the third party connected to the private wireless network 104 from one of the number of PBX terminals 106. Referring to FIG. 6, a call originating from a public wireless mobile station 124 is connected to the public wireless network 102, arrow 232. From the public wireless network 102 the call is connected over the A-link 142 to the private wireless network 104, arrow 234, and from there transmitted to a public wireless mobile station 144, arrow 236. Subsequent to the call between the public wireless mobile station 124 and private wireless mobile station 144 having been established, the PBX terminal 106 is joined to the call over the link from the private wireless network 104, arrow 238. The virtual identity module then provides subscriber and security information to the public wireless network 102 over the A-link 142 and through the private wireless network 104, arrow 240. Alternatively, the subscriber and security information may be provided only when the party on the private wireless mobile station 144 leaves the three party call.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best use the invention and various embodiments with various modifications as are suited to the particular use contemplated. It is intended that the scope of the invention be defined by the claims appended hereto and their equivalents.

We claim:

1. A private wireless network for communicating with a public wireless network coupled thereto via an A-link, the private wireless network comprising at least one virtual identity module to enable a terminal of a private branch exchange (PBX) coupled to the private wireless network to communicate with the public wireless network via the A-link.

2. A private wireless network according to claim 1, further comprising a Private A-link Intelligent Multiplexor (PALIM) interface function for coupling public wireless mobile stations, private wireless mobile stations and the terminal of the PBX to the public wireless network.

3. A private wireless network according to claim 1, wherein the at least one virtual identity module includes subscriber identification and security information.

4. A private wireless network according to claim 1, further comprising a memory system, and wherein the at least one virtual identity module comprises subscriber identification and security information stored in the memory system.

5. A private wireless network according to claim 1, wherein further comprising a card holder/reader, and wherein the at least one virtual identity module comprises a card held in the card holder/reader.

6. A private wireless network according to claim 1, wherein the public wireless network comprises a Global System for Mobile Communications (GSM) network, and wherein the virtual identity module is a virtual subscriber identity module (virtual SIM).

7. A private wireless network according to claim 1, wherein the public wireless network comprises a third-generation mobile communications (3G) network, and wherein the virtual identity module is a virtual universal subscriber identity module (virtual USIM).

8. A private wireless network according to claim 1, wherein the private wireless network further comprises a processor to execute algorithms to authenticate, encrypt outbound signals and decrypt inbound signals, and wherein the virtual identity module comprises authentication and encryption keys for the associated PBX terminal.

9. A private wireless network according to claim 1, wherein the private wireless network further comprises a processor to provide supplementary services, and wherein the virtual identity module comprises supplementary service keys to support supplementary services for the associated PBX terminal.

10. A communication system comprising:
a public wireless network;
a private branch exchange (PBX) having a plurality of PBX terminals coupled thereto; and
a private wireless network coupled to the public wireless network via an A-link and to the PBX, the private wireless network comprising means for enabling the plurality of PBX terminals to communicate with the public wireless network via the A-link.

11. A communication system according to claim 10, wherein the means for enabling the plurality of PBX terminals to communicate with the public wireless network via the A-link comprises a Private A-link Intelligent Multiplexor (PALIM) interface function and a plurality of virtual identity modules.

12. A communication system according to claim 11, wherein the private wireless network further comprises a processor to execute algorithms to authenticate, encrypt outbound signals and decrypt inbound signals, and wherein each of the plurality of virtual identity module comprises authentication and encryption keys for the associated PBX terminal.

13. A communication system according to claim 11, wherein the private wireless network further comprises a processor to provide supplementary services, and wherein each of the plurality of virtual identity module comprises supplementary service keys to support supplementary services for the associated PBX terminal.

14. A communication system according to claim 11, wherein the means for enabling the plurality of PBX terminals to communicate with the public wireless network via the A-link comprises subscriber identification and security information associated with each of the plurality of PBX terminals.

15. A communication system according to claim 14, wherein the private wireless network further comprises a memory system, and wherein the subscriber identification and security information associated with each of the plurality of PBX terminals is stored in the memory system.

16. A communication system according to claim 11, wherein the private wireless network further comprises a card holder/reader, and wherein the subscriber identification and security information associated with each of the plurality of PBX terminals is stored in a card held in the card holder/reader.

17. A communication system according to claim 11, wherein the public wireless network comprises a Global System for Mobile Communications (GSM) network, and wherein the means for enabling the plurality of PBX terminals to communicate with the public wireless network via the A-link comprises a virtual subscriber identity module (virtual SIM).

18. A communication system according to claim 11, wherein the public wireless network comprises a third-generation mobile communications (3G) network, and wherein the means for enabling the plurality of PBX terminals to communicate with the public wireless network via the A-link comprises a virtual universal subscriber identity module (virtual USIM).

19. In a communication system having a public wireless network, a private branch exchange (PBX) with a plurality of PBX terminals coupled thereto, and a private wireless network coupled to the public wireless network via an A-link and to the PBX, a method of enabling the plurality of PBX terminals to communicate with the public wireless network via the A-link, the method comprising steps of:
receiving in the private wireless network call information from one of the plurality of PBX terminals;
providing subscriber identification and security information for the PBX terminal to the public wireless network; and
coupling the PBX terminal to the public wireless network over the A-link.

20. A method according to claim 19, wherein the private wireless network comprises a Private A-link Intelligent Multiplexor (PALIM) interface function, and wherein the step of coupling the PBX terminal to the public wireless network over the A-link comprises the step of coupling the PBX terminal to the public wireless network over the A-link via the PALIM interface function.

21. A method according to claim 20, wherein the private wireless network comprises a plurality of virtual identity modules each having subscriber identification and security information stored therein, and wherein the step of providing subscriber identification and security information for the PBX terminal to the public wireless network comprises the step of providing subscriber identification and security information from a virtual identity module associated with the PBX terminal.

22. A method according to claim 21, wherein the public wireless network comprises a Global System for Mobile Communications (GSM) network, and wherein the plurality of virtual identity module comprise virtual subscriber identity modules (virtual SIMs).

23. A method according to claim 21, wherein the public wireless network comprises a third-generation mobile communications (3G) network, and wherein the plurality of virtual identity module comprise virtual universal subscriber identity modules (virtual USIMs).

24. A method according to claim 21, wherein the private wireless network further comprises a memory system, and wherein the step of providing subscriber identification and security information for the PBX terminal to the public wireless network comprises the step of reading subscriber identification and security information from that stored in the memory system.

25. A method according to claim 21, wherein the private wireless network further comprises a card holder/reader, and wherein the step of providing subscriber identification and security information for the PBX terminal to the public wireless network comprises the step of reading subscriber identification and security information stored in a card held in the card holder/reader.

26. A method according to claim 21, wherein the communication system further includes a public switched telephone network (PSTN), and wherein the step of receiving in the private wireless network call information from one of the plurality of PBX terminals comprises the step of receiving in the private wireless network call information for a call originating in the PSTN and forwarded from one of the plurality of PBX terminals.

27. A method according to claim 21, wherein the private wireless network is capable of communicating with public wireless mobile stations and private wireless mobile stations, and wherein the step of receiving in the private wireless network call information from one of the plurality of PBX terminals comprises the step of receiving in the private wireless network call information for a call originating from a public wireless mobile station or a private wireless mobile station and forwarded from one of the plurality of PBX terminals.

28. A method according to claim 21, wherein the private wireless network is capable of coupling communications between the public wireless network and public wireless mobile stations and private wireless mobile stations, and wherein the step of receiving in the private wireless network call information from one of the plurality of PBX terminals comprises the step of receiving in the private wireless network call information for a call originating from a three party call between a first party connected to the public wireless network, a second party connected to the private wireless network over a public wireless mobile station or a private wireless mobile station, and a third party connected to the private wireless network from one of the plurality of PBX terminals.

29. A method according to claim 28, wherein the step of receiving in the private wireless network call information from one of the plurality of PBX terminals comprises the step of receiving in the private wireless network call information from the PBX terminal when the second party is disconnected from the three party call,
thereby enabling uninterrupted communication between the first party connected to the public wireless network and the third party connected to the private wireless network from one of the plurality of PBX terminals.

30. A method according to claim 21, wherein the private wireless network comprises a plurality of virtual identity modules each having subscriber identification and security information stored therein, and wherein the method further comprises the initial step of registering the virtual identification modules associated with each of the plurality of PBX terminals with the public wireless network and private wireless network.

31. A method according to claim 30, wherein the step of registering the virtual identification modules associated with the public wireless network and private wireless network is performed when each of the plurality of PBX terminals is provisioned.

32. A method according to claim 30, wherein the step of registering the virtual identification modules associated with the public wireless network and private wireless network is performed dynamically prior to the PBX terminal placing an outgoing call to the public wireless network over the private wireless network and A-link.
